(19) United States
(12) Patent Application Publication
(10) Pub. No.: US 2023/0314906 A1
(43) Pub. Date: Oct. 5, 2023

(54) ADAPTIVE APERTURE SIZE AND SHAPE BY ALGORITHM CONTROL

(71) Applicant: GM GLOBAL TECHNOLOGY OPERATIONS LLC, Detroit, MI (US)

(72) Inventors: Tzvi Philipp, Bet Shemesh (IL); Eran Kishon, Hod Hasharon (IL)

(73) Assignee: GM GLOBAL TECHNOLOGY OPERATIONS LLC, Detroit, MI (US)

(21) Appl. No.: 17/713,462

(22) Filed: Apr. 5, 2022

(51) Int. Cl. G03B 9/02; G06V 20/56; H04N 5/225; G06T 7/50; G06T 7/60; G02B 27/28; G03B 7/00; B60W 60/00; B60W 40/04

(52) U.S. Cl. CPC G03B 9/02; G06V 20/56; H04N 5/2254; G06T 7/50; G06T 7/60; G02B 27/283; G03B 7/00; B60W 60/001; B60W 40/04; G06T 2207/30252; G02B 26/0833

(57) ABSTRACT

An optical system, and method related thereto, includes a camera configured to capture images. The camera has an adaptive aperture plane configured to change both an aperture size and an aperture shape in response to an aperture signal. The camera also includes a first polarized surface and second polarized surface positioned relative to the adaptive aperture plane, such that light strikes the first polarized surface, the adaptive aperture plane, then the second polarized surface. First and second lenses may be located on opposite sides of the adaptive aperture plane. An image sensor is beyond the second polarized surface and configured to output image signals, and a processor is configured to execute image perception algorithms based on the image signals. The image perception algorithms alter the aperture size and the aperture shape by sending an aperture signal from the processor to the camera for subsequent captured images.

### INTRODUCTION

The present disclosure relates to methods, mechanisms, and systems for altering apertures of optical systems.

### SUMMARY

An optical system, which may be used for an autonomous vehicle, is provided. The optical system includes a camera configured to take one or more captured images. The camera includes an adaptive aperture plane, which is configured to provide an adjustable aperture for the camera. The adaptive aperture plane is configured to change both an aperture size and an aperture shape in response to an aperture signal.

The camera also includes a first polarized surface on a first side of the adaptive aperture plane, relative to light passage. A first lens and a second lens are positioned within the light flow path. A second polarized surface is located on a second side of the adaptive aperture plane, relative to light passage, such that light strikes the first polarized surface, then the adaptive aperture plane, then the second polarized surface.

An image sensor is beyond the second polarized surface and configured to output one or more image signals. A processor is operatively configured to execute one or more image perception algorithms based on the image signals from the image sensor. The image perception algorithms alter the aperture size and the aperture shape by sending the aperture signal from the processor to the camera for subsequent captured images. When used with an autonomous vehicle, the captured images from the camera may be used to control movement of the autonomous vehicle.

In some configurations of the optical system, the image perception algorithms interact with a stored library of shapes to determine relevant shapes in the captured images, such that the image perception algorithms recognize object geometries based on the library of shapes. The adaptive aperture plane may be formed by, for example, a liquid crystal element or a digital micromirror device. The optical system may have a transmissive alignment, such that the first lens, the first polarized surface, the adaptive aperture plane, the second polarized surface, the second lens, and the image sensor are substantially aligned.

Additionally, the optical system may have a reflective alignment that includes a mirror. In the reflective alignment, the first lens is substantially aligned with the mirror and the adaptive aperture plane, and the first lens is at an angle of approximately 90 degrees relative to the second lens and the image sensor. Furthermore, the first polarized surface and the second polarized surface are at an angle of between 40-50 degrees relative to the first lens, the second lens, and the image sensor.

A method of controlling an optical system for an autonomous vehicle is also provided, and includes capturing one or more images with the optical system, which includes an adaptive aperture plane configured with a changeable aperture size and aperture shape in response to an aperture signal. The method may execute an image perception algorithm on the captured images, such that the image perception algorithm recognizes at least one of pedestrians or other vehicles in the captured images.

The method may further execute an aperture control algorithm on the captured image, such that the aperture control algorithm analyzes a scene of the captured images. The method determines whether the aperture size or aperture shape should change with either of the image perception algorithm or the aperture control algorithm. If the aperture size or aperture shape needs to be modified, the method sends the aperture signal from, for example, a voltage controller to adjust the adaptive aperture plane and capture subsequent images. If the aperture size or aperture shape does not need to be modified, the method captures subsequent images. Movement of the autonomous vehicle may be controlled based on the captured images.

In some configurations, the method includes determining shapes in the captured images by comparing shapes in the captured images to a library of shapes, with the image perception algorithm or the aperture control algorithm. The aperture size or aperture shape may be modified based on the determined shapes.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic diagram of an autonomous vehicle having at least one sensor pod and at least one optical system.

FIG. 2 is a schematic diagram of an optical system having an adaptive aperture plane with a transmissive set up or alignment.

FIG. 3 is a schematic diagram of an optical system having an adaptive aperture plane with a reflective set up or alignment.

FIG. 4 schematically illustrates a flow chart diagram illustrating one possible algorithm for adjusting an aperture opening of an adaptive aperture plane.

FIGS. 5A-5D, schematically illustrate different aperture openings created by an adaptive aperture plane, with FIG. 5A illustrating a polygonal aperture opening, which may have additional sides; FIG. 5B illustrating an oval aperture opening rotated at an angle; FIG. 5C illustrating a complex geometric shape aperture opening; and FIG. 5D illustrating an amorphous shape aperture opening.

### DETAILED DESCRIPTION

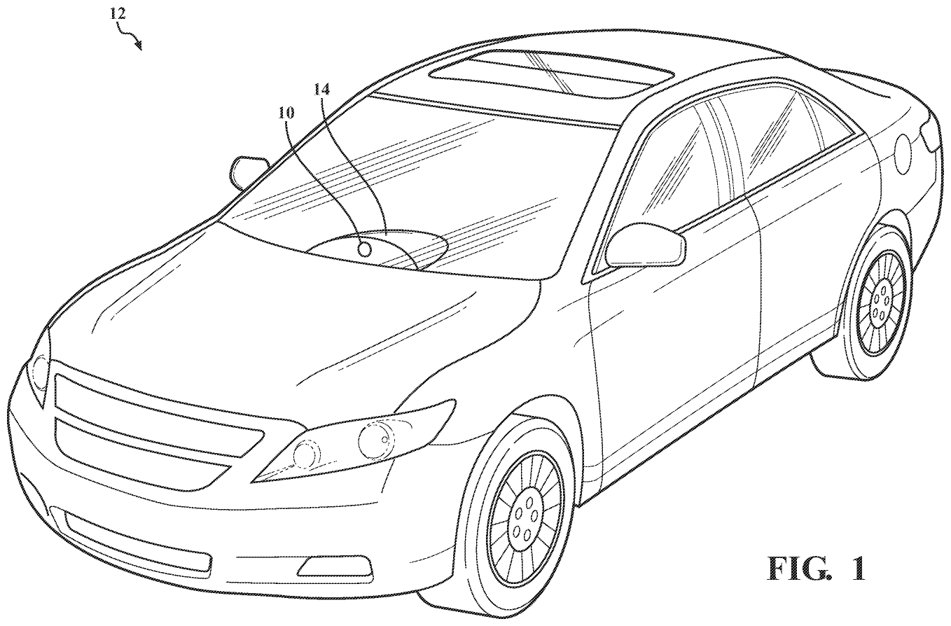

Referring to the drawings, like reference numbers refer to similar components, wherever possible. All figure descriptions simultaneously refer to all other figures. FIG. 1 schematically illustrates an optical system 10 usable with, without limitation, an autonomous vehicle 12, all of which is shown highly schematically. The autonomous vehicle 12 may be, for example and without limitation, a traditional vehicle, an electric vehicle, or a hybrid vehicle.

The autonomous vehicle 12 includes one or more sensor pods 14, one of which may house the optical system 10. Note, however, that the optical system 10 may be located anywhere that would provide some benefit for the autonomous vehicle 12. Additionally, while the sensor pod 14 is shown near the dashboard of the autonomous vehicle 12, it may be located elsewhere. For example, and without limitation, the sensor pod 14 may be located on the exterior or interior of the roof of the autonomous vehicle 12. Furthermore, there may be additional sensors pods 14. Note that the optical system 10 may be used independently of the autonomous vehicle 12. In addition to the optical system 10, the autonomous vehicle 12 may have numerous other sensors, including, without limitation: autonomous vehicles are equipped with many sensors: light detection and ranging (LiDAR), infrared, sonar, or inertial measurement units.

A generalized control system or controller is operatively in communication with components of, at least, the optical system 10, the autonomous vehicle 12, or the sensor pod 14, and is configured to execute any of the methods, processes, and algorithms described herein. The controller includes, for example and without limitation, a non-generalized, electronic control device having a preprogrammed digital computer or processor, a memory, storage, or non-transitory computer-readable medium used to store data such as control logic, instructions, lookup tables, etc., and a plurality of input/output peripherals, ports, or communication protocols. The controller is configured to execute or implement all control logic or instructions described herein and may be communicating with any of the sensors described herein or recognizable by skilled artisans.

Furthermore, the controller may include, or be in communication with, a plurality of sensors, including, without limitation, those configured to inform the movement or actions of the autonomous vehicle 12. Numerous additional systems may be used in controlling and determining movement of the autonomous vehicle 12, as will be recognized by those having ordinary skill in the art. The controller may be dedicated to the specific aspects of the autonomous vehicle 12 described herein, or the controller may be part of a larger control system that manages numerous functions of the autonomous vehicle 12.

The drawings and figures presented herein are diagrams, are not to scale, and are provided purely for descriptive and supportive purposes. Thus, any specific or relative dimensions or alignments shown in the drawings are not to be construed as limiting. While the disclosure may be illustrated with respect to specific applications or industries, those skilled in the art will recognize the broader applicability of the disclosure. Those having ordinary skill in the art will recognize that terms such as “above,” “below,” “upward,” “downward,” et cetera, are used descriptively of the figures, and do not represent limitations on the scope of the disclosure, as defined by the appended claims. Any numerical designations, such as “first” or “second” are illustrative only and are not intended to limit the scope of the disclosure in any way. Any use of the term, “or,” whether in the specification or claims, is inclusive of any specific element referenced and also includes any combination of the elements referenced, unless otherwise explicitly stated.

Features shown in one figure may be combined with, substituted for, or modified by, features shown in any of the figures. Unless stated otherwise, no features, elements, or limitations are mutually exclusive of any other features, elements, or limitations. Furthermore, no features, elements, or limitations are absolutely required for operation. Any specific configurations shown in the figures are illustrative only and the specific configurations shown are not limiting of the claims or the description.

All numerical values of parameters (e.g., of quantities or conditions) in this specification, including the appended claims, are to be understood as being modified in all instances by the term about whether or not the term actually appears before the numerical value. About indicates that the stated numerical value allows some slight imprecision (with some approach to exactness in the value; about or reasonably close to the value; nearly). If the imprecision provided by about is not otherwise understood in the art with this ordinary meaning, then about as used herein indicates at least variations that may arise from ordinary methods of measuring and using such parameters. In addition, disclosure of ranges includes disclosure of all values and further divided ranges within the entire range. Each value within a range and the endpoints of a range are hereby all disclosed as separate embodiments.

When used, the term “substantially” refers to relationships that are ideally perfect or complete, but where manufacturing realties prevent absolute perfection. Therefore, substantially denotes typical variance from perfection. For example, if height A is substantially equal to height B, it may be preferred that the two heights are 100.0% equivalent, but manufacturing realities likely result in the distances varying from such perfection. Skilled artisans will recognize the amount of acceptable variance. For example, and without limitation, coverages, areas, or distances may generally be within 10% of perfection for substantial equivalence. Similarly, relative alignments, such as parallel or perpendicular, may generally be considered to be within 5%.

The autonomous vehicle 12 may have a communications system that is capable of sharing information determined by the controller, for example, or other parts of the autonomous vehicle 12 with locations outside of the autonomous vehicle 12. For example, and without limitation, the communications system may include cellular or Wi-Fi technology that allows signals to be sent to centralized locations, such as clouds or communications networks. It is envisioned that the methods and mechanisms described herein may occur on the autonomous vehicle 12, in a cloud system, a combination of both, or via other computational systems, such that the controller, or functions thereof, may be executed externally to the autonomous vehicle 12.

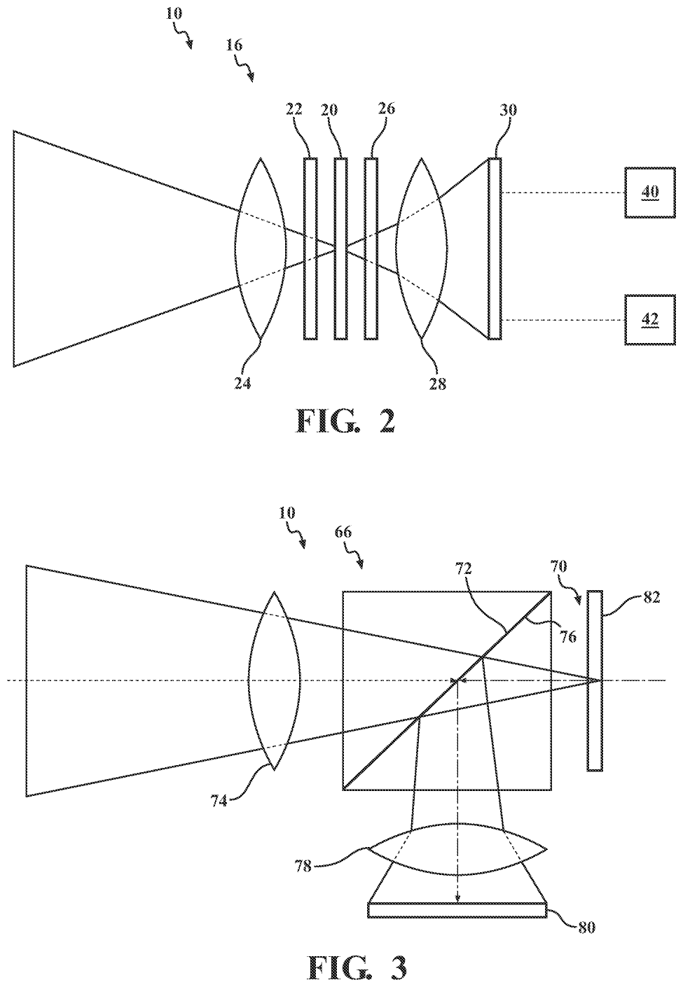

FIGS. 2 and 3 show example alternative configurations for portions of the optical system 10. FIG. 2 shows a transmissive alignment and FIG. 3 shows a reflective alignment. Note that the transmissive and reflective alignments are not limiting, and skilled artisans will recognize additional configurations for portions of the optical system 10. Light flow is illustrated in a highly schematic fashion and the components may not be to scale relative to one another.

As schematically illustrated in FIG. 2, the optical system 10 includes at least one camera 16, which is configured to digitally capture one or more images. The camera 16 is representative of many different types of equipment and may be used to take images, video, or combinations thereof

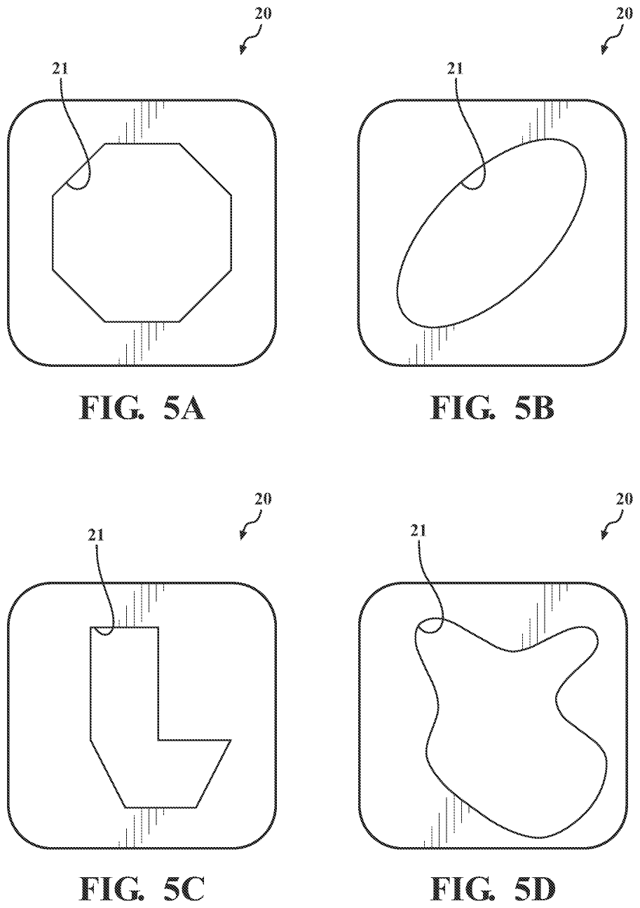

The camera 16 includes many components for operation, some of which are illustrated in FIG. 2. An adaptive aperture plane 20 is configured to provide a highly adjustable aperture for the camera 16. The adaptive aperture plane 20 is configured to change both an aperture size and an aperture shape in response to an aperture signal. A few examples of differently sized and/or differently shaped aperture openings 21 are schematically illustrated in FIGS. 5A-5D.

The adaptive aperture plane 20 may be controlled by, for example and without limitation, a voltage controller, which may be incorporated into several of the components shown and described. Other control mechanisms for the adaptive aperture plane 20 will be recognized by skilled artisans.

The camera 16 includes a first polarizer or first polarized surface 22 on a first side of the adaptive aperture plane 20. All references to alignment and/or direction are substantially relative to light flow or light passage through the camera 16. A first lens 24 is located before the first polarized surface 22.

The camera 16 includes a second polarizer or second polarized surface 26 on a second side of the adaptive aperture plane 20, opposite the first polarized surface 22. A second lens 28 is located after the second polarized surface 26. Note that all references to any lens includes groups of lenses having one or more lenses cooperating to modify light passage within the camera 16.

All lenses are shown highly schematically, such that light flow may not be representative of actual changes through the illustrated lenses. Note that the layout of elements for the camera 16 in FIG. 2 is exemplary and non-limiting. In particular, several of the illustrated elements, including, without limitation, the first polarized surface 22, the first lens 24, the second polarized surface 26, and the second lens 28, may be ordered differently relative to the other elements. Skilled artisans will recognize the specific order of elements, based on the needs of the optical system 10 and/or the physical constraints of its location.

The camera 16 includes an image sensor 30 in communication with an image signal processor 40. The image sensor 30 is located beyond the second polarized surface 26 and is configured to output one or more image signals. The image sensor 30 and the image signal processor 40 may be combined into the same, or closely related hardware. The image signal processor 40 may be referred to as an ISP, and is dedicated hardware used to process the sensor image to produce the final output, such as, for example and without limitation, JPEG images. Note that it is also possible to perform operations common on an ISP on a CPU or GPU. The image signal processor 40 and the image sensor 30 may be referred to interchangeably herein.

A camera processor 42 is operatively configured to execute one or more image perception algorithms based on the image signals from the image signal processor 40. In some configurations, and without limitation, the image signal processor 40 and the camera processor 42 may be integrated into the same hardware, different hardware, or combinations thereof. However, the description will refer to the processors separately, as they may, or may not, be executing different functions and/or algorithms.

The image perception algorithms of the camera processor 42 may be used to alter the aperture size and the aperture shape by sending the aperture signal from the camera processor 42, or through other components, to the camera 16. The autonomous vehicle 12 may use the images processed by the image perception algorithms to control the path, and general movement, of the autonomous vehicle 12. Any of the functions of the image signal processor 40, the camera processor 42, or both, may be conducted by the generalized control system or controller for the autonomous vehicle 12. Those having ordinary skill in the art will recognize different image perception algorithms usable for the optical system 10 and the autonomous vehicle 12, including, without limitation, machine vision algorithms, robotic navigation algorithms, machine learning, or computer vision algorithms.

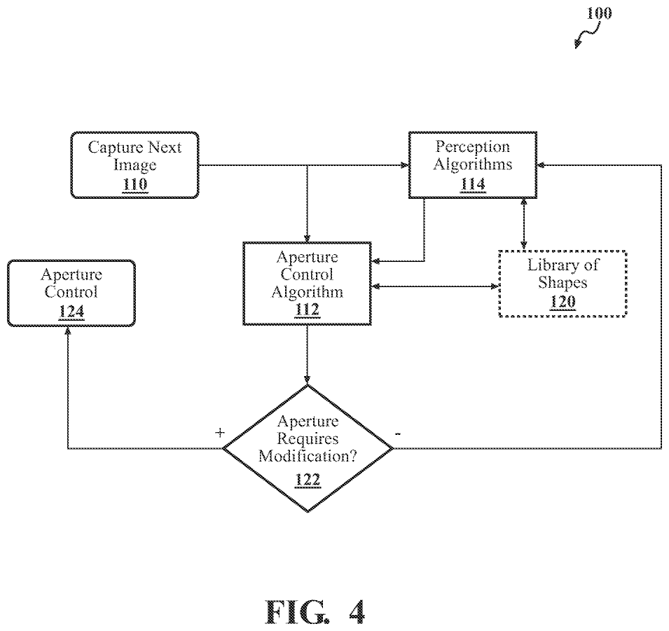

In some configurations of the optical system 10, and as illustrated in the flow chart of FIG. 4, the image perception algorithms may interact with a stored library of shapes to determine relevant shapes in the captured images, such that the image perception algorithms recognize object geometries based on the library of shapes.

In the optical system 10, the adaptive aperture plane 20 may be formed by, for example and without limitation, a liquid crystal (LC) element, a digital micromirror device, or combinations thereof. Skilled artisans will recognize additional structures capable of providing an adaptive aperture plane 20 configured to change both the aperture size and the aperture shape to form different aperture openings 21, as schematically illustrated in FIGS. 5A-5D.

Where the adaptive aperture plane 20 is formed from a liquid crystal (LC) device, it can create infinite different shapes. The LC device is made up of an LC pixelated array or LC cells, where each pixel controls the optical polarization phase of the given LC cell via a drive voltage applied to the specific cell. Each cell refers to a pixel and there can be hundreds to thousands of pixels across the adaptive aperture plane 20.

The light intensity passing through the adaptive aperture plane 20 is controlled by the voltage, which in turn changes the polarization phase of the light transmitted through the cell. For example, and without limitation, to block light the first polarized surface 22 will pass light linearly polarized light in one direction, such as horizontal, as recognized by skilled artisans. The second polarized surface 26 after the LC device is oriented in the same direction.

Therefore, if a voltage is applied from horizontal to vertical—such as a half wave phase—the light transmitted through the adaptive aperture plane 20 will then be vertically polarized and cannot pass through the horizontally oriented second polarized surface 26. If one wants light to pass through, no voltage phase should be applied to the LC device, such that no change to the transmitted light is induced. Alternatively, the voltage applied may be a full wave or multiples thereof. Therefore, to transmit light, the voltage applied will be to rotate the light from horizontal to vertical and the second polarizer, the second polarized surface 26, is in the vertical direction.

As schematically illustrated in FIG. 2, the camera 16 of the optical system 10 may have a transmissive alignment, which may also be referred to as a non-reflective or single direction alignment. For the transmissive alignment, the first lens 24, the first polarized surface 22, the adaptive aperture plane 20, the second polarized surface 26, the second lens 28, and the image sensor 30 are substantially aligned. Note that the schematic diagram of the transmissive alignment in FIG. 2 is illustrative only, and that modifications to the alignment, and/or to the order of components, may be made, as recognized by skilled artisans.

Alternatively, as schematically illustrated in FIG. 3, a camera 66 of the optical system 10 may have a reflective or multi-directional alignment. In the example camera 66 shown in FIG. 3, an adaptive aperture plane 70 is at an angle relative to a first polarized surface 72 and a second polarized surface 76. The first polarized surface 72 and the second polarized surface 76 may be formed along substantially the same structure or may be separate structures that are generally stacked or aligned. For example, and without limitation, the first polarized surface 72 and the second polarized surface 76 may be part of a cube structure, with the first polarized surface 72 and the second polarized surface 76 along the hypotenuse.

A first lens 74 is substantially aligned with a mirror 82 and the adaptive aperture plane 70. The first lens 74 is at an angle of about 90 degrees relative to a second lens 78 and an image sensor 80. The first polarized surface 72 and the second polarized surface 76 are at an angle of between 40-50 degrees relative to the first lens 74, the second lens 78, and the image sensor 80. The mirror 82 reflects light passing through the first polarized surface 72 and the adaptive aperture plane 70 back toward the second polarized surface 76.

Note that the first polarized surface 72 may be configured such that light passes through to be selectively blocked by the adaptive aperture plane 70. However, the second polarized surface 76 may be configured to reflect the selectively polarized light downward toward the second lens 78 and the image sensor 80. Any of the polarized surfaces discussed herein may be, for example, and without limitation, linear or circular polarizing filters, the specific benefits of the use of each will be recognized by those having ordinary skill in the art. Furthermore, any of the polarized surfaces discussed herein may be, for example, and without limitation, dichroic, reflective, birefringent, thin film, or combinations thereof

All lenses are shown highly schematically, such that light flow may not be representative of actual changes through the illustrated lenses. Note that the layout of elements for the camera 66 in FIG. 3 is exemplary and non-limiting. In particular, several of the illustrated elements, including, without limitation, the first polarized surface 72, the first lens 74, the second polarized surface 76, and the second lens 78, may be ordered differently relative to the other elements. Skilled artisans will recognize the specific order of elements, based on the needs of the optical system 10 and/or the physical constraints of its location.

FIG. 4 schematically illustrates a flow chart diagram illustrating one possible algorithm or method 100 for adjusting the aperture opening 21 of the adaptive aperture plane 20. The steps of the method 100 are not shown in limiting order, such that steps may be rearranged, as would be recognized by skilled artisans. Additionally, note that the connecting arrows shown in FIG. 4 are not limiting, and different arrangements may be made, such that additional arrows may be included.

Step 110: Start/Capture Next Image. At step 110 the method 100 initializes or starts by capturing one or more images with the optical system 10, such as with either the camera 16 or the camera 66, or another digital camera device. The method 100 may begin operation when called upon by the controller, may be constantly running, or may be looping iteratively.

Furthermore, the method 100 may be carried out by the image signal processor 40, the camera processor 42, both processors, or may be conducted by another generalized control system or controller. Several of the steps may move, depending on the configuration, between the image signal processor 40 and the camera processor 42, which is likely part of the camera 16 or the camera 66.

Step 112: Aperture Control Algorithm. The method 100 executes one or more aperture control algorithms on the captured images. The aperture control algorithms may provide several features, but at least analyzes a scene of the captured images.

Step 114: Perception Algorithms. The method 100 executes one or more image perception algorithms on the captured images. The image perception algorithms analyze the captured images in order to identify relevant objects. For example, and without limitation, the image perception algorithms may recognize at least pedestrians or other vehicles in the captured images. Where the optical system 10 is operating an autonomous vehicle 12, the image perception algorithms may also be used to determine control—i.e., direction, speed, movement—of the autonomous vehicle 12 in conjunction with its other sensors and systems.

Optional Step 120: Library of Shapes. In some configurations, the method 100 utilizes a library of shapes to assist in identifying relevant shapes in the captured images. Therefore, the method 100 is determining shapes in the captured images by comparing shapes in the captured images to the library of shapes. This may occur via either the image perception algorithm, the aperture control algorithm, both, or alternative algorithms. The library of shapes may be prepopulated with known shapes that are recognizable via machine image analysis. The library of shapes may communicate back and forth with both the perception algorithms and the aperture control algorithms.

Step 122: Aperture Requires Modification? At step 122, the method 100 determines whether the aperture size or aperture shape of the aperture opening 21 created by the adaptive aperture plane 20 should change. This process may occur via the image perception algorithm, the aperture control algorithm, or alternative algorithms. If the aperture size or aperture shape does not need to be modified by the adaptive aperture plane 20, the method 100 captures subsequent images and/or reverts to the image perception algorithms.

Step 124: Aperture Control. Where step 122 determines that the aperture size or aperture shape needs to be modified, such that a new aperture opening 21 will be created by the adaptive aperture plane 20, the method 100 sends the aperture signal from, for example and without limitation, the voltage controller. The aperture signal adjusts the aperture opening 21 provided by the adaptive aperture plane 20, such that the method 100 and the optical system may capture subsequent images with the improved aperture opening 21. This may include modifying the aperture size and/or aperture shape based on the determined or identified shapes from the library of shapes.

The autonomous vehicle 12 may be controlling its movement based on the captured images with the improved aperture opening 21. After step 124, the method 100 ends. In many configurations, the method 100 will loop constantly or at a regular interval, as will be recognized by skilled artisans.

FIGS. 5A-5D, schematically illustrate different aperture openings created by the adaptive aperture plane 20. FIG. 5A illustrates a polygonal aperture opening 21, which may have additional sides. In many configurations, the polygonal aperture opening 21 may approximate a circle, as is done by mechanical apertures in alternative cameras. Alternatively, because the adaptive aperture plane 20 can create nearly any shape, the aperture opening 21 may be an exact circle, as opposed to the approximated circle created by the alternative mechanical aperture devices. Control over the adaptive aperture plane 20 will be recognizable to skilled artisans, whether an LC device or digital micromirror device is used.

FIG. 5B illustrates an oval, or oval-like, aperture opening 21. The oval aperture opening 21 is also rotated at an angle, which may promote machine vision for the shapes in the captured images taken therewith.

FIG. 5C illustrates a complex geometric shape aperture opening 21. Typical, alternative, aperture openings and camera optics have been based upon mimicking human perception. However, machine vision does not necessarily have the same imaging constraints or requirements as human sight. These differences can be magnified when determining which aspects of the raw image affect the algorithm used to process those images, such as the image perception algorithms used to determine the path of the autonomous vehicle 12.

Therefore, the optical system 10 has feedback between the image perception algorithms and the camera operation, which may further enhance the performance of the image perception algorithms and, therefore, the performance of the autonomous vehicle 12. FIG. 5D illustrates an amorphous shape aperture opening 21. The complex geometric shape shown in FIG. 5C, and the amorphous shape shown in FIG. 5D may be better utilized by the machine vison systems that may be used to control the autonomous vehicle 12 or to provide other details gleaned from the captured images.

The detailed description and the drawings or figures are supportive and descriptive of the subject matter herein. While some of the best modes and other embodiments have been described in detail, various alternative designs, embodiments, and configurations exist.

Any embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

1. An optical system, comprising:
a camera configured to take one or more captured images, having:
an adaptive aperture plane, configured to provide an adjustable aperture for the camera, wherein the adaptive aperture plane is configured to change an aperture size and an aperture shape in response to an aperture signal;
a first polarized surface on a first side of the adaptive aperture plane;
a first lens;
a second polarized surface on a second side of the adaptive aperture plane, opposite the first polarized surface;
a second lens; and
an image sensor beyond the second polarized surface, configured to output one or more image signals; and
a processor operatively configured to execute one or more image perception algorithms based on the image signals from the image sensor,
wherein the image perception algorithms alter the aperture size and the aperture shape by sending the aperture signal from the processor to the camera.

2. The optical system of claim 1,
wherein the image perception algorithms interact with a stored library of shapes to determine relevant shapes in the captured images, such that the image perception algorithms recognize object geometries based on the stored library of shapes.

3. The optical system of claim 2,
wherein the adaptive aperture plane is formed by a liquid crystal element.

4. The optical system of claim 3,
wherein the first lens, the first polarized surface, the adaptive aperture plane, the second polarized surface, the second lens, and the image sensor are substantially aligned.

5. The optical system of claim 4,
wherein the first lens is located prior to the adaptive aperture plane, relative to light flow, and
wherein the second lens is located after to the adaptive aperture plane, relative to light flow.

6. The optical system of claim 3, further comprising:
a mirror,
wherein the first lens is substantially aligned with the mirror and the adaptive aperture plane,
wherein the first lens is at an angle of about 90 degrees relative to the second lens and the image sensor, and
wherein the first polarized surface and the second polarized surface are at an angle of between 40-50 degrees relative to the first lens, the second lens, and the image sensor.

7. The optical system of claim 6,
wherein the first lens is located prior to the adaptive aperture plane, relative to light flow, and
wherein the second lens is located after to the adaptive aperture plane, relative to light flow.

8. The optical system of claim 2,
wherein the adaptive aperture plane is formed by a digital micromirror device.

9. The optical system of claim 8,
wherein the first lens, the first polarized surface, the adaptive aperture plane, the second polarized surface, the second lens, and the image sensor are substantially aligned.

10. The optical system of claim 8, further comprising:
a mirror,
wherein the first lens and the adaptive aperture plane are substantially aligned with the mirror,
wherein the first lens is at an angle of about 90 degrees relative to the second lens and the image sensor, and
wherein the first polarized surface and the second polarized surface are at an angle of between 40-50 degrees relative to the first lens, the second lens, and the image sensor.

11. An optical system for an autonomous vehicle, comprising:
a camera configured to take one or more captured images, having:
an adaptive aperture plane, configured to provide an adjustable aperture for the camera, wherein the adaptive aperture plane is configured to change an aperture size and an aperture shape in response to an aperture signal;
a first polarized surface on a first side of the adaptive aperture plane, relative to light passage;
a first lens;
a second polarized surface on a second side of the adaptive aperture plane, opposite the first polarized surface;
a second lens; and
an image sensor beyond the second polarized surface, configured to output one or more image signals; and
a processor operatively configured to execute one or more image perception algorithms based on the image signals from the image sensor,
wherein the image perception algorithms alter the aperture size and the aperture shape by sending the aperture signal from the processor to the camera for subsequent captured images, and
wherein the captured images from the camera are used to control movement of the autonomous vehicle.

12. The optical system for an autonomous vehicle of claim 11,
wherein the adaptive aperture plane is formed by a liquid crystal element.

13. The optical system for an autonomous vehicle of claim 12,
wherein the image perception algorithms interact with a stored library of shapes to determine relevant shapes in the captured images, such that the image perception algorithms recognize object geometries based on the stored library of shapes.

14. The optical system for an autonomous vehicle of claim 13,
wherein the first lens, the first polarized surface, the adaptive aperture plane, the second polarized surface, the second lens, and the image sensor are substantially aligned.

15. The optical system for an autonomous vehicle of claim 13, further comprising:
a mirror,
wherein the first lens is substantially aligned with the mirror and the adaptive aperture plane,
wherein the first lens is at an angle of about 90 degrees relative to the second lens and the image sensor, and
wherein the first polarized surface and the second polarized surface are at an angle of between 40-50 degrees relative to the first lens, the second lens, and the image sensor.

16. The optical system for an autonomous vehicle of claim 11,
wherein the adaptive aperture plane is formed by a digital micromirror device.

17. The optical system for an autonomous vehicle of claim 16,
wherein the first lens, the first polarized surface, the adaptive aperture plane, the second polarized surface, the second lens, and the image sensor are substantially aligned.

18. The optical system for an autonomous vehicle of claim 16:
a mirror,
wherein the first lens is substantially aligned with the mirror and the adaptive aperture plane,
wherein the first lens is at an angle of about 90 degrees relative to the second lens and the image sensor, and
wherein the first polarized surface and the second polarized surface are at an angle of between 40-50 degrees relative to the first lens, the second lens, and the image sensor.

19. A method of controlling an optical system for an autonomous vehicle, comprising:
capturing one or more images with the optical system, which includes an adaptive aperture plane, wherein the adaptive aperture plane is configured with a changeable aperture size and aperture shape in response to an aperture signal;
executing an image perception algorithm on the captured images, wherein the image perception algorithm recognizes at least one of pedestrians or other vehicles in the captured images;
executing an aperture control algorithm on the captured image, wherein the aperture control algorithm analyzes a scene of the captured images;
determining whether the aperture size or aperture shape should change with one of the image perception algorithm or the aperture control algorithm;
if the aperture size or aperture shape needs to be modified, sending the aperture signal from a voltage controller to adjust the adaptive aperture plane and capturing subsequent images;
if the aperture size or aperture shape does not need to be modified, capturing subsequent images; and
controlling movement of the autonomous vehicle based on the captured images.

20. The method of controlling an optical system for an autonomous vehicle of claim 19, further comprising:
determining shapes in the captured images by comparing shapes in the captured images to a library of shapes, with the image perception algorithm or the aperture control algorithm; and
modifying the aperture size or aperture shape based on the determined shapes.
